(19) United States
(12) Patent Application Publication
(10) Pub. No.: US 2003/0079133 A1
(43) Pub. Date: Apr. 24, 2003

(54) Method and system for digital rights management in content distribution application

(75) Inventors: Gerd Breiter, Wildberg (DE); Oliver Petrik, Stuttgart (DE); Werner Ederer, Schoenaich (DE); Jonathan Munson, Putnam Valley, NY (US); Giovanni Pacifici, New York, NY (US); Alaa S. Youssef, Valhalla, NY (US); Abdelsalam Helal, Gainesville, FL (US)

Correspondence Address: William Kinnaman, Jr., IBM Corporation, Intellectual Property Law Department, 2455 South Road, M/S P386, Poughkeepsie, NY, 12601, US

(73) Assignee: INTERNATIONAL BUSINESS MACHINES CORPORATION, ARMONK, NY

(21) Appl. No.: 09/982,203

(22) Filed: Oct. 18, 2001

(51) Int. Cl. H04L 9/00

(52) U.S. Cl. 713/182

(57) ABSTRACT

The invention described herein introduces a system which binds the content to a person or any other entity like a company. So duplication of the content and rendering of content is only allowed to a well defined number of devices. The devices used in a system according to the present invention are provided for playing unencrypted content as well. Thus, users are enabled to play their currently existing audio CDs with the same device.

### BACKGROUND OF THE INVENTION

1. Field of the Invention

The present invention generally relates to information systems. Particularly, the present invention relates to a method and system for controlling access rights to digital content in a distributed information system (DIS), e.g., the Internet.

2. Description of the Related Art

Content producers such as film and music producers are currently desperately searching for digital rights management solutions which allow them to protect content from unauthorized duplication. This includes the prevention of uncontrollable downloads through the network within P2P (point to point) scenarios, such as Napster, and also unauthorized duplication of content on media, such as CD or DVD.

U.S. Pat. No. 6,141,754 by David M. Choy, assigned to International Business Machines Corporation, Armonk, N.Y. (US), filed Nov. 28, 1997, issued Oct. 31, 2000, “Integrated method and system for controlling information access and distribution”, discloses a framework for protecting a distributed content entity, wherein the distributed content entity includes a protection specification and an information entity. The framework includes an information unit for storing the protected information entity and a protection specification unit for storing the protection specification. The protection specification unit includes an access control enforcement manager and an enhanced access control enforcement manager. The framework also includes an access checking unit connected to the protection specification unit and the information unit. The access checking unit checks whether a user has a privilege to access the protected information entity based on the protection specification and the access control manager, and checks whether the requested access meets conditions determined based on the protection specification and enforced by the enhanced access control manager. An example of the enhanced access control manager is a terms and conditions enforcement manager for enforcing the terms and conditions of an agreement relating to permitted uses of the protected information entity.

Thus, an information content entity is provided including both an information entity and a protection specification, specifying protection attributes of an information entity, in which the protection specification is attached to the information entity thereby allowing the protection specification to be distributed with the information entity.

From U.S. Pat. No. 6,237,099 by Takeshi Kurokawa, assigned to Fuji Xerox Co., Ltd., Tokyo, Japan, filed Feb. 13, 1997, issued May 22, 2001, “Electronic document management system”, an electronic document management system is known that is applied to an information processing system having at least one authorization system for checking the user for validity and authorizing the user if the user is valid and storage means for storing electronic documents. The electronic document management system comprises access right list assignment means for assigning an access right list setting an authorization system name, user name, and access type to an electronic document prepared by any application software product, compression and coding means for compressing or coding or compressing and coding an electronic document with an access right list as required, decompression and decoding means for decompressing or decoding or decompressing and decoding an electronic document stored on the storage means of one file system, access authorization means for inquiring of the authorization system specified by the user and gaining authorization of the user, access right recognition means for collating user information for authorization with a given access right list for recognizing the corresponding access type, display and edit means for performing electronic document processing in accordance with the recognized access type, and input means for accepting an access request to an electronic document stored in the storage means from the user. The input means is connected to the access right list assignment means and the access authorization means and is used by the user to set the authorization system name, user name, and access right in the access right list assignment means and specify the authorization system name, user name, and password in the access authorization means.

So, according to the invention, the access right to an electronic document allowed for any user of any operating system can be registered in the electronic document itself and when the user accesses the electronic document, the access authorization means inquires of the specified operating system if the user is to be authorized.

U.S. Pat. No. 6,236,971 by Mark J. Stefik et. al., assigned to Contentguard Holdings, Inc., Wilmington, Del. (US) and Xerox Corporation, Stamford, Conn. (US), filed November 10, 1997, issued May 22, 2001, “System for controlling the distribution and use of digital works using digital tickets”, describes a system for controlling the distribution and use of digital works using digital tickets. A ticket is an indicator that the ticket holder has already paid for or is otherwise entitled to some specified right, product or service. In the present invention, a “digital ticket” is used to enable the ticket holder to exercise usage rights specifying the requirement of the digital ticket. Usage rights are used to define how a digital work may be used or distributed. Specific instances of usage rights are used to indicate a particular manner of use or distribution. A usage right may specify a digital ticket which must be present before the right may be exercised. For example, a digital ticket may be specified in a copy right of a digital work, so that exercise of the copy right requires the party that desires a copy of the digital work be in possession of the necessary digital ticket. After a copy of the digital work is successfully sent to the requesting party, the digital ticket is “punched” to indicate that a copy of the digital work has been made. When the ticket is “punched” a predetermined number of times, it may no longer be used.

Furthermore, a method is taught for controlling access to digital works in a network of computer based systems. First, a plurality of usage rights are attached to a digital work that requires controlled access. Then, for an associated one of the attached plurality of usage rights, it is specified that a digital ticket must be possessed by a requesting repository as a condition for performance of the corresponding usage right to be granted. Subsequently the digital work and attached usage rights are stored in a first repository. Then, the digital ticket is created and stored in a second repository, whereby the digital ticket itself is an instance of a digital work. Subsequently, a third repository obtains a copy of the digital ticket from the second repository. Afterwards, the third repository transmits a request to access the digital work to the first repository and the request for access specifies the associated one of the plurality of usage rights that specifies the digital ticket. Later, the first repository queries the third repository for the digital ticket and the third repository confirms possession of the digital ticket to the first repository and, finally, the first repository validates the third repository possesses the digital ticket and transmits the digital work to the third repository.

A key feature of the invention is that usage rights are permanently “attached” to the digital work. Copies made of a digital work will also have usage rights attached. Thus, the usage rights and any associated fees assigned by a creator and subsequent distributor will always remain with a digital work.

According to the teaching of U.S. Pat. No. 5,765,152 by John S. Erickson, assigned to Trustees of Dartmouth College, Hanover, N.H. (US), filed Oct. 13, 1995, issued Jun. 9, 1998, “System and method for managing copyrighted electronic media”, copyrighted electronic media are packaged in a secure electronic format, and copyright management for that media. Users are connected to the server, e.g., through a computer network or the Internet, to enable data transfers and to transact licenses to utilize the media. Packaged and registered on associated registration server, which serves to provide on-line licensing electronic media are typically created by an author or derivative user of the work. Once the packaged media is registered on the server, the media is made available for limited use and possible license through an authorization server. This limited use is specified within the minimum permissions data set assigned to each packaged media. Without a license, users are typically permitted to view the packaged media, through a system which unpackages the media, but cannot save or otherwise transfer the media without obtaining auxiliary permissions to do so from the authorization server. The electronic media is authenticated through digital signatures and optional encryption.

The subject matter described in U.S. Pat. No. 5,920,861 by Edwin J. Hall, assigned to InterTrust Technologies Corp., Sunnyvale, Calif. (US) filed Feb. 25, 1997, issued Jul. 6, 1999, “Techniques for defining using and manipulating rights management data structures”, relates to techniques for defining, creating, and manipulating rights management data structures. More specifically, this invention provides systems and processes for defining and/or describing at least some data characteristics within a secure electronic rights management container. The present invention also provides techniques for providing rights management data structure integrity, flexibility, interoperability, user and system transparency, and compatibility.

One secure container for safely and securely storing and transporting digital content is the DigiBox™ container developed by InterTrust Technologies Corp. of Sunnyvale, Calif. (US). DigiBox containers are tamper-resistant digital containers that can be used to package any kind of digital information such as, for example, text, graphics, executable software, audio and/or video. The rights management environment in which DigiBox containers are used allows commerce participants to associate rules with the digital information (content). The rights management environment also allows rules (herein including rules and parameter data controls) to be securely associated with other rights management information, such as for example, rules, audit records created during use of the digital information, and administrative information associated with keeping the environment working properly, including ensuring rights and any agreements among parties. The DigiBox electronic container can be used to store, transport and provide a rights management interface to digital information, related rules and other rights management information, as well as to other objects and/or data within a distributed, rights management environment. This arrangement can be used to provide an electronically enforced chain of handling and control wherein rights management persists as a container moves from one entity to another. This capability helps support a digital rights management architecture that allows content rightsholders (including any parties who have system authorized interests related to such content, such as content republishers or even governmental authorities) to securely control and manage content, events, transactions, rules and usage consequences, including any required payment and/or usage reporting. This secure control and management continues persistently, protecting rights as content is delivered to, used by, and passed among creators, distributors, repurposers, users, payment disagregators, and other value chain participants.

A descriptive data structure provides an abstract representation of a rights management data structure such as a secure container. The abstract representation may describe, for example, the layout of the rights management data structure. It can also provide metadata describing or defining other characteristics of rights management data structure use and/or processing. For example, the descriptive data structure can provide integrity constraints that provide a way to state rules about associated information. The abstract representation can be used to create rights management data structures that are interoperable and compatible with one another. This arrangement preserves flexibility and ease of use without compromising security.

In U.S. Pat. No. 6,098,056 by David J. Rusnak et. al., assigned to International Business Machines Corporation, Armonk, N.Y. (US), filed Nov. 24, 1997, issued Aug. 1, 2000, “System and method for controlling access rights to and security of digital content in a distributed information system, e.g., Internet”, a system and method is described for limiting access to and preventing unauthorized use of an owner's digital content stored in an information network and available to clients under authorized conditions. The network includes at least one server coupled to a storage device for storing the limited access digital content encrypted using a random-generated key, known as a document encryption key (DEK). The DEK is further encrypted with the server's public key, using a public/private key pair algorithm and placed in a digital container stored in a storage device and including as a part of the meta-information which is in the container. The client's workstation is coupled to the server for acquiring the limited access digital content under the authorized condition. A trusted information handler (TIH) is validated by the server after the handler provides a data signature and type of signing algorithm to transaction data descriptive of the purchase agreement between the client and the owner. After the handler has authenticated, the server decrypts the encrypted DEK with its private key and reencrypts the DEK with the handler's public key ensuring that only the information handler can process the information. The encrypted DEK is further encrypted with the client's public key personalizing the digital content to the client. The client's program decrypts the DEK with his private key and passes it along with the encrypted content to the handler which decrypts the DEK with his private key and proceeds to decrypt the content for displaying to the client.

Hence, it is ensured that only the TIH that has been verified by the server is able to display the content previously purchased by the client, whereby the TIH is protecting the digital content from unauthorized use after decryption.

Hence, existing digital rights management (DRM) systems do not allow users to freely move their content among their own devices. On the contrary, the content is basically bound to the machine to which it is initially downloaded. This results in significant inconvenience to the user. In the case of prerecorded media, users may wish to make copies for their own use. They may, for example, want to have one copy of, e.g., a CD (compact disk) for their domicile and another for their automobile. Current DRM-based digital music distribution systems place technological restrictions on this. While some systems enable content to be “checked out” to other devices, they only do so through special software mechanisms, and support only certain devices. Furthermore, if a device with stored content on it fails, the content is lost. A content distributor may allow users to reacquire their content at no charge, but the process for this will vary from distributor to distributor, and the user is responsible for knowing exactly what content was lost and from which distributor each item was purchased.

In order to increase the end user acceptance in digital right management systems, the digital rights management environment, e.g. rendering devices, has to allow users to freely move their content among their own devices.

### SUMMARY OF THE INVENTION

Starting from this, one object of the present invention is to provide an efficient method and system for controlling access rights to digital content in a distributed information system (DIS), e.g., the Internet.

Another object of the present invention is to prevent unauthorized copying of the content without significantly restricting the end user. That means that the system must work in such a way that the end user ideally does not realize that the content is protected as long as it is used in an authorized environment.

Yet another object of the present invention is to provide a digital rights management solution that allows the users to store and copy content for use on their own devices. For example if they download digital content through their PCs they must be able to copy that content on a CD-like device which enables them to play the content on their home CD-like player or a player in a car.

The foregoing objects are achieved by a method and a system as laid out in the independent claims. Further advantageous embodiments of the present invention are described in the sub claims and are taught in the following description.

The invention described herein introduces a system which binds the content to a person or any other entity like a company. So duplication of the content and rendering of content is only allowed to a well-defined number of devices. The devices used in a system according to the present invention are provided for playing unencrypted content as well. Thus, users are enabled to play their currently existing audio CDs with the same device.

With this invention of a digital rights management system according to the present invention it is possible to separate digital content, i.e., any data that is subject of a distribution, and content rights/keys, i.e., specified usage rights and respective access keys. Therefore, the digital rights management system according to the present invention is a user-related DRM system having at least the following advantages.

It departs from conventional digital right management technology in strongly associating rights with users rather than devices. Rights may not be stored along with the content. Therefore the access to digital content is much less restrictive and commerce in digital content is more flexible and pervasive. This is a paradigm shift from “commerce in content” to “commerce in rights”.

On the other hand, the invention also enables the end user to distribute the content in his own environment without significantly restricting the user. This will increase the user acceptance remarkably. Therefore the content producing and selling industry and the end user will both benefit from this invention.

According to the present invention a secure repository is provided to hold the content rights and keys needed to encrypt the distributed digital content. Such a secure repository will be called a rights wallet. The rights wallet can reside on any personal device, such as a PDA, a cell phone, a smart card or even a storage device, such as a CD or DVD. A rights wallet may also be located on a public network such as the Internet.

A content distribution portal functions as a framework or an authority for distributing the digital content. In order to enable a user to access digital content the content distribution portal sends the respective usage rights associated with the digital content and a general key necessary to decrypt the content in encrypted form to the rights wallet. The content, which is encrypted by this general key, can be downloaded from the content distribution portal or acquired via any suitable storage device, such as CD, DVD.

Tables with content references, content rights and (decryption) keys are needed together for rendering content. Therefore, the lists with content rights, keys and registered rendering devices are bound to the rights wallet. The list with the content reference is copied to a rendering device. Hence, one option to render digital content on a rendering device is to establish a communication link between the rights wallet and the rendering device. However, alternatively rendering devices may be registered with the content distribution portal in order to enable them to render content without the need of a connection to the rights wallet.

Assuming that the user is registered with the content distribution portal and possesses a rights wallet and a rendering device, after ordering content, the user has the content rights and keys stored in his rights wallet and the content is transferred to his rendering device. Therefore, the user is enabled to render the acquired content using the rendering device and his rights wallet. When a rights wallets gets connected to the content distribution portal, content rights and keys of the user currently registered for the particular user can be downloaded from the portal or synchronized with the data stored in the rights wallet. Thus, a rights wallet is able to synchronize their tables keeping the information stored with the portal.

When users register with the content distribution portal, they get a unique ID assigned. They also can specify which rendering devices they want to register and they may subsequently charged accordingly when ordering content. Initially there will be at least one (primary) rights wallet registered at the content distribution portal for each registered user. However, if the user needs more than one rights wallet, he can register additional rights wallets with the portal. If desired, the functionality of such additional rights wallets may be restricted to predetermined access rights, e.g., for playback only. A family, for example, may need additional rights wallets, since every member wishes to have its own rights wallet, like today's using of cell phones. Then each of them is able to access the content on unregistered devices.

It is acknowledged that secured content can only be rendered on devices which are equipped with a compatible client digital rights management software. If the rendering device is a PC-like device, users can download the client digital rights management software instantly when ordering digital content from the content distribution portal. If the rendering device is a dedicated player or printer, the device is provided for having the functionality of the respective client digital rights management software.

Each new rendering device of a user may be registered at the portal. However, a registration is needed, if the user wants to use the rendering devices without connection to a rights wallet. On registration, the rendering device is added to the list of rendering devices per user. So the content distribution portal is able to maintain a list of rendering devices a user can render content on. This can be an automated process which hooks the device on an appliance which is capable of reading the portal user ID for example from the rights wallet and register the rendering device to the content distribution portal.

As aforementioned, each different content is encrypted with a general key and only the general key is encrypted with respect to the portal user. If users download encrypted content, the rights associated with that content, the keys to decrypt the content and the list of registered devices are downloaded to the rights wallet. The encrypted content is downloaded to a rendering device or transmitted via a storage device. Alternatively, the actual list of registered devices is transparently downloaded to the rights wallet, whenever a user connects to the portal. This enables the user to always copy the most actual list of registered devices.

Three different cases can be distinguished when talking about rendering of digital content in accordance with the present invention.

In the first case, the content is provided on a storage device. When the user tries to render content, the rendering device initially checks if it is allowed to render that content by looking up whether or not a rights wallet is stored on the storage device as well. If yes, the rendering device checks whether or not this rights wallet contains in the table of registered devices its own identification. If it find its own identification, then it decrypts and renders the content. Otherwise, it refuses to render unless one of the next cases is successful.

Still regarding the first case, the rendering device is able to decrypt the registered devices and keys tables with the general key. This general key is known by the rendering device and not stored on the storage device. The proposed solution can benefit from cryptographic schemes, which uses a matrix of keys that gives the effect of a single global key while in fact every device type has a subset of keys different from those used by other devices.

Rendering content on a public rendering device, e.g., in a hotel room, may also be performed in accordance to an aspect of the present invention. Especially at public places, like hotel rooms, content is usually not stored on rendering devices. Therefore these rendering devices have to be able to access the content. This may be performed by storage device readers, such as CD or DVD players, or over the Internet via streaming or downloading services. In other words content can be provided on a storage device by the user or streamed/downloaded from the portal. Since the content rights and keys are stored in the rights wallet, the user only needs to carry the rights wallet to be able to access all digital content he would also be able to access in the own domicile.

In the second case, the rendering device and rights wallet are connected to each other via any kind of communication link. When the user tries to render content, the rendering device contacts the rights wallet and it checks whether or not it has the appropriate access rights for rendering the particular digital content. On success, the rendering device is allowed to render the content. To do so, it gets the needed key from the rights wallet. Otherwise, it refuses to render unless the third case applies.

In the third case, the content rights and keys are bound to a rendering device. When the user tries to render content, the rendering device looks up respective tables stored in the rendering device. If it is allowed to render the content, it renders the content, otherwise it refuses.

The concept of the present invention also allows copying content to storage devices. Together with the encrypted content, the tables containing the content reference, the associated rights, the (encrypted) general keys and registered devices may be written to a storage device. The tables with registered devices and (encrypted) general keys are both encrypted with a general key, which is known by registered rendering devices. With that technique content can be rendered on any registered rendering device without the need of the presence of a rights wallet.

In order to bind digital content to a rendering device, the rendering device has to be registered to the portal user. Every time a rendering device renders content, it needs to be in touch with a rights wallet. Since this is not possible at any time, it is possible to copy content rights and keys from a rights wallet to a rendering device. The rights wallet looks up its registered device list for the rendering device ID. If the list obtains this ID, the rights wallet copies content rights and keys to the rendering device (according to the content rights).

If a rights wallet is damaged or sold by a user, the user is requested to deregister that device with the portal. He can do this automatically by hooking up the rights wallet to the portal and deregistering it. In that case all tables in the rights wallet are cleared. If the rights wallet is damaged, lost or stolen, he can manually deregister it at the portal. Then it is still possible for somebody, who uses the rights wallet, to render all the (old) content which is referenced in the rights wallet, but no new content. If such a rights wallet is later connected to the portal, the portal may clear all tables in it.

The deregistration of a rendering device is similar to the deregistration of a rights wallet. Therefore the rendering device is still able to render the (old) content on storage devices and all content that is bounded to it, but no new content.

The renderers such as CD players are normally connected to a home stereo equipment. Therefore the user always has the possibility of recording the encrypted content and copying it to a tape or conventional CD. As an additional hint for sources of these types of unauthorized copies the content rendered could be watermarked when being decrypted and rendered.

### BRIEF DESCRIPTION OF THE DRAWINGS

The above, as well as additional objectives, features and advantages of the present invention, will be apparent in the following detailed written description.

The novel features of the invention are set forth in the appended claims. The invention itself, however, as well as a preferred mode of use, further objectives, and advantages thereof, will best be understood by reference to the following detailed description of an illustrative embodiment when read in conjunction with the accompanying drawings, wherein:

FIG. 1A is a general block diagram which illustrates a first view of a system in accordance with the present invention;

FIG. 1B is a general block diagram which illustrates a second view of a system in accordance with the present invention;

FIG. 2 is a more detailed block diagram of an embodiment of the present invention;

FIG. 3 is a flowchart illustrating a method of registering digital content in accordance with the present invention;

FIG. 4 is a flowchart illustrating a method of acquiring a rights wallet in accordance with the present invention;

FIG. 5 is a flowchart illustrating a method of registering a user with a content distribution portal (CDP) in accordance with the present invention;

FIG. 6 is a flowchart illustrating a method of registering one or more rendering devices with a content distribution portal in accordance with the present invention;

FIG. 7 is a flowchart illustrating a method of ordering from a content distribution portal in accordance with the present invention;

FIG. 8A is a flowchart illustrating a method of rendering digital content in accordance with the present invention;

FIG. 8B is a continuation of the flowchart of FIG. 8A;

FIG. 9 is a flowchart illustrating a method of binding digital content to a rendering device in accordance with the present invention;

FIG. 10 is a flowchart illustrating a method of copying digital content to a storage device in accordance with the present invention;

FIG. 11A is a flowchart illustrating a method of rendering digital content on a public rendering device in accordance with the present invention;

FIG. 11B is a continuation of the flowchart of FIG. 11A;

FIG. 12 is a flowchart illustrating a method of deregistering a rights wallet in accordance with the present invention; and

FIG. 13 is a flowchart illustrating a method of deregistering a rendering device in accordance with the present invention.

### DETAILED DESCRIPTION OF THE INVENTION

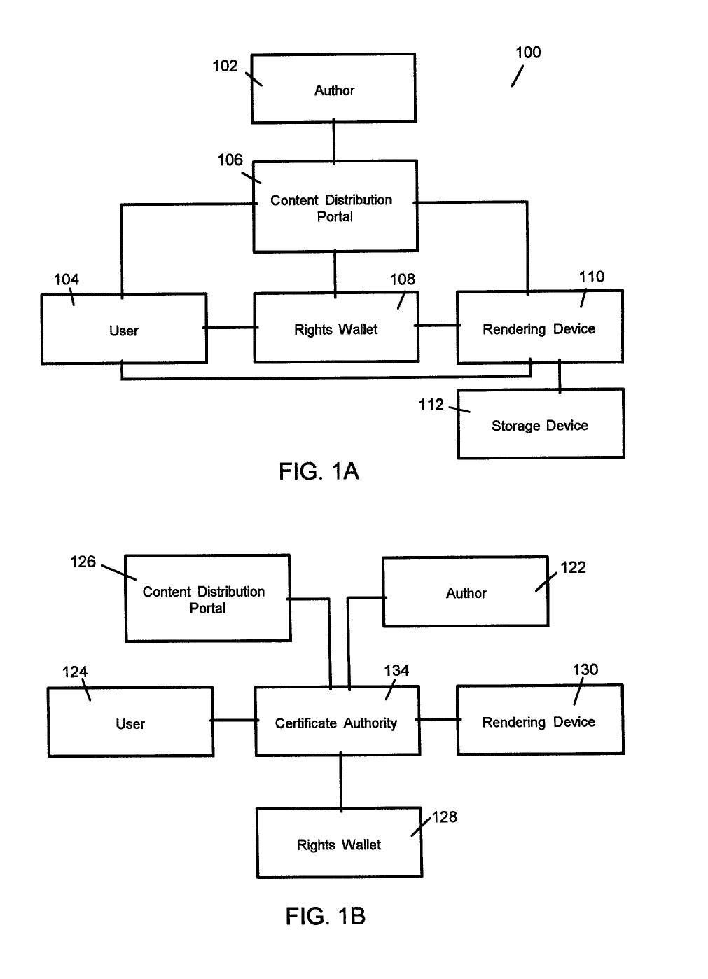

In FIG. 1A a general block diagram is shown depicting a first view of a system 100 in accordance with the present invention including an author 102, an user 104, a content distribution portal 106, a rights wallet 108, a rendering device 110 and a storage device 112. The solid lines between the aforementioned subjects depict communication links which may be needed for allowing transmission of information between such subjects. Such communication links may be formed by a distributed information system (DIS), such as the Internet. The communication link may partly or entirely be formed by a wireless communication connection, such as Bluetooth, GSM (Global System for Mobile Communications), GPRS (General Packet Radio Service), or UMTS (Universal Mobile Telecommunications System).

The author 102 may be formed by any individual person or a group of persons which created a work, such as a work of literature, a work of art, a structured compilation of data, a piece of music, a recording, a movie or any form of multimedia data. The author 102 may also be formed by a legal entity holding the copyrights of such a work. Before distribution the work created by the author is digitized to facilitate further digital processing, such as storing, encryption and transmission over a digital communication line. In the following the digitized work of the author is referred to as digital content constituting the offering to be distributed and marketed.

Similarly to the author 102, the user 104 may also be formed either by an individual person, a group of persons or a legal entity. The user wants to access, retrieve and/or purchase the content offered by the content distribution portal (CDP) 106.

The content distribution portal 106 is a “gateway” to the digital content supplied by the authors 102. Hence, the CDP 106 is the primary entry point for users to participate in the system. It may be formed by an Internet or intranet web site providing the infrastructure to search, find, access, retrieve and/or purchase the digital content. The CDP may comprise one or more server computers including sufficient storage devices for providing and maintaining the content, additional content data and user data. Additional content data includes the access and distribution rights and conditions of the respective content as specified by the author and/or the CDP management. The user data comprises either personal data as a registered user or a pseudonym representing a particular user. Optionally the CDP might offer a search engine and/or links to useful pages, such as more detailed information about the authors, and possibly news or other services. In short, it holds all information regarding users, associated rights wallets, rendering devices and digital content.

The rights wallet is formed by a secure digital repository for storing tables holding lists of access rights associated with digital content and respective decryption and/or encryption keys. It further allows tamperproof storage and transmission of the tables and information stored. For an implementation of the rights wallet the Cryptolope® technology by International Business Machines Corporation could be used. The rights wallet may be stored either on a commercial computer system, such as a personal computer, or on any other digital device, such as a personal digital assistant (PDA), a cellular phone or a smart card, or even on a public network such as the Internet. Furthermore, the rights wallet is furnished with a unique identification number that may be formed by a TCP/IP (Transmission Control Protocol/Internet Protocol) address, preferably according to the IPv6 (Internet Protocol version 6) standard, which offers a larger number of addresses. Authorized access to the information stored in the rights wallet is facilitated by an interface to a communication link as described above. The rights wallet is normally associated with a user, which may be represented by a unique identification number, e.g., an account number, a digital certificate or a pseudonym.

The rendering device (RD) is a device that is able to render content, that is basically the conversion of the digital content into a user-accessible form. For example, if the digital content is formed by a video clip being stored according to the MPEG-1, MPEG-2 or MPEG-4 (Moving Picture Experts Group) standard, the RD would recreate a video clip from the stored data. If the digital content is formed by a work of literature, the RD would compose a visual representation of the work or even a printout on paper. Hence, the RD may be formed by a variety of devices, each specialized for the conversion of digital content stored in a specific format. However, one RD may be able to render a wide variety of different formats. It is acknowledged that the RD may be realized as a separate device, such as a MP3 (MPEG-1 audio layer 3) player, a CD (compact disk) player, a DVD (Digital Versatile Disc) player and a printer or it my be implemented as a computer program running on a commercial computer system. It shall be understood that the RD can also be reached via one of the aforementioned communication links. Some of devices can also copy content onto storage devices such as CD or DVD. Similarly to the rights wallet, the RD has also a unique identification number assigned to it and is equipped with a tamperproof storage for keeping decryption and/or encryption keys. Optionally the digital content may be stored in the tamperproof storage or a separate storage provided by the RD itself or the computer system on which the RD is running.

The storage device (SD) is capable of storing the digital content. It can either be realized by an optical device, such as a CD or DVD, or by a flash erasable programmable read-only memory. The storage device is configured to hold protected content. Therefore, it is able to store different tables provided for controlling the access to the protected content by the rendering device.

The entire system is embedded in a public key infrastructure (PKI) as illustrated in FIG. 1B. The public key infrastructure is a system of public key encryption using digital certificates from certificate authorities and other registration authorities that verify and authenticate the validity of each party involved in an electronic transaction. Public key encryption is an encryption scheme, introduced by Diffie and Hellman in 1976, where each person gets a pair of keys, called the public key and the private key. Each person's public key is published while the private key is kept secret. Messages are encrypted using the intended recipient's public key and can only be decrypted using his private key. RSA encryption is an example of a public-key cryptographic system. The certificate authority is an entity, typically a company, that issues digital certificates to other entities, organizations and individuals to allow them to prove their identity to others.

In FIG. 1B, there are shown the same subjects as depicted in FIG. 1A, namely, an author 122, an user 124, a content distribution portal 126, a rights wallet 128 and a rendering device 130. However, for the sake of clarity, in FIG. 1B only the communication links to a certificate authority 134 are depicted rather than the communication links between the shown subjects.

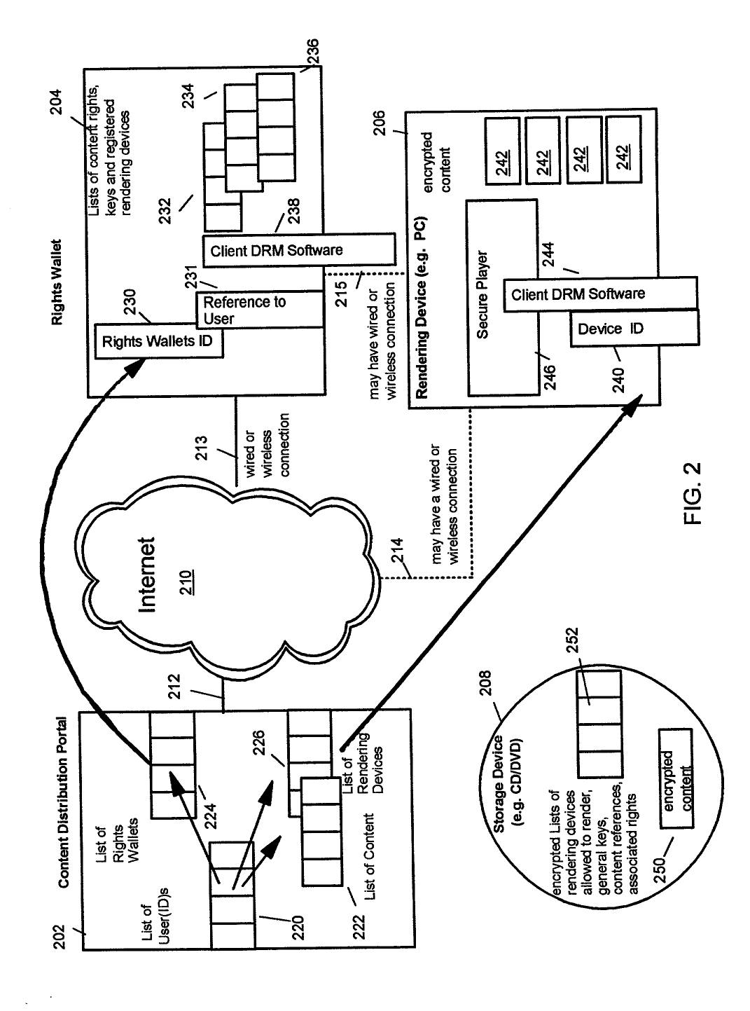

In FIG. 2 there is depicted a more detailed block diagram of an embodiment of the present invention. The illustrated scheme shows the components which interact in such a system. However, it is acknowledged that again it is simplified to show only the relevant parts of the invention and reduced to one user with one rights wallet and one rendering device.

Depicted are a content distribution portal 202, a rights wallet 204, a rendering device 206, a storage device 208 and some communication links illustrated, by way of example, by the Internet 210 and by wired or wireless connection 212, 213, 214 and 215.

The content distribution portal 202 is the primary entry point for users to participate in the system. It holds a first table 220 keeping a list of user IDs. Each entry in the first table 220 is associated with related tables respectively keeping information about the digital content in a second table 222 and a list of rights wallets in a third table 224 and a list of rendering devices in a fourth table 226 registered for a particular user.

The rights wallet 204 is identified by a rights wallet ID 230 that is stored as a reference to the rights wallet 204 in the third table 224 of the content distribution portal 202. The rights wallet 204 is associated with a user (not shown) which is represented through a unique ID (231), e.g. an account number. In a music distribution system, this person may be part of a community (such as Napster) where it registers once and gets a user ID assigned. The rights wallet further contains some from of read/write storage to store tables holding contents rights, encrypted general keys and registered rendering devices as depicted by first, second and third rights wallet lists 232, 234, 236. The rights wallet further contains client digital rights management (DRM) software 238 which interacts with a digital processing device functioning as a platform for realizing the rights wallet, such as a PDA (personal digital assistant), a cell phones or smart card or a program running on a commercial computer. However, a rights wallet may also be located on a public network such as the Internet. A user may have multiple rights wallets as already indicated by the list of rights wallets 224 related to a user ID stored in the first table 220 in the content distribution portal 202.

The rendering device 206 is identified through an unique identifier 240, such as a TCP/IP (e.g., IPv6) ID. There are two classes of rendering devices 206. The first class of rendering devices 206, such as a PC, are able to communicate with the content distribution portal 202 to download content via the Internet 210 and render such digital content. This class of devices can also copy the downloaded content onto storage devices 208 such as writeable CDs/DVDs. The second class of rendering devices 206 are only able to render digital content which is stored on storage devices, i.e., devices comparable to conventional CD/DVD-players. Both classes of rendering devices 206 may have a wireless or wired interface which allows them to hook up to the rights wallet using the connection 215. They may also contain some form of read/write storage to be able to store tables holding the encrypted content as illustrated by boxes 242.

Adapted client DRM software 244 controls the communication of the rendering device 206 to the rights wallet and the content distribution portal 202 via the Internet 210. Furthermore, the client DRM software 244 interacts with a secure player 246. The secure player 246 is adapted to render the encrypted digital content by using the respective keys provided by the rights wallet or the storage device itself without enabling the user to copy decrypted digital content.

Finally, the storage device 208 is capable of storing the digital content in encrypted form as illustrated by box 250. The storage device 208 may be realized by either an optical device such as CD/DVD or flash RAM such as a smart media card or a memory stick. Hence, it may be a write once/read only device or a write multiple device. In the case of a CD, for example, the mixed mode facility of modern CDs may be used to store the data. This would give rendering devices the capability to render encrypted content and also unencrypted content stored on the device in today's CD format. Optionally, in a dedicated area the storage device may be adapted to store encrypted lists of rendering devices allowed to render, general keys, content references and associated rights as illustrated by box 252.

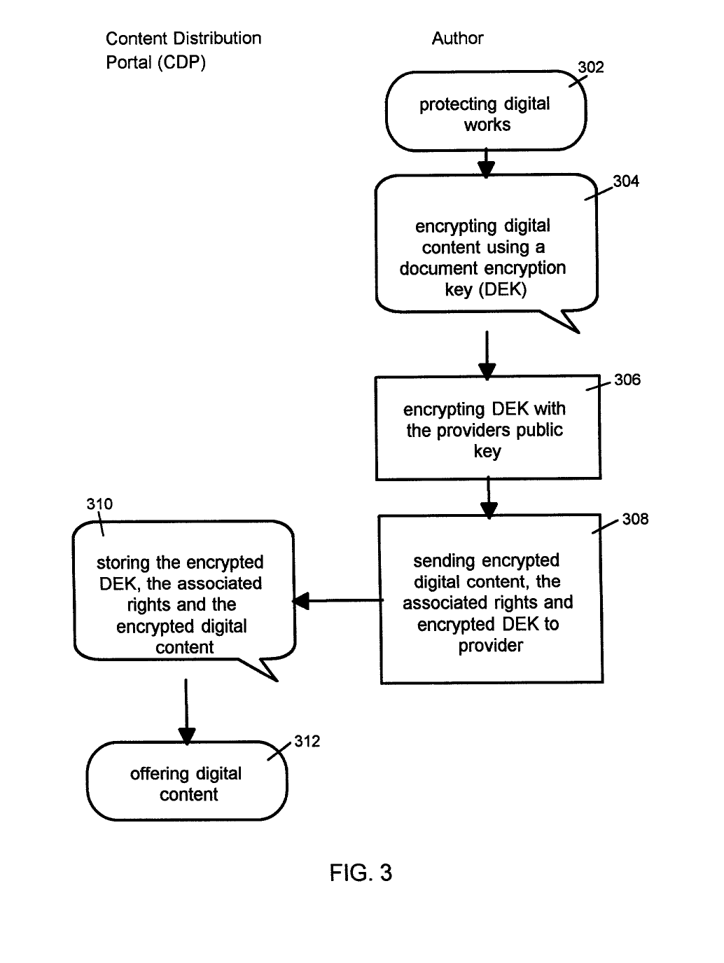

FIG. 3 shows a flowchart illustrating a method of registering digital content in accordance with the present invention. Assume that an author wishes to protect a digital work forming digital content to be distributed over the Internet (block 302). To do so, the author encrypts the digital content using a document encryption key (DEK) in a first step (block 304). For performance reasons the encryption of the digital content may be performed with a symmetric encryption algorithm, e.g., DES, whereby the DEK itself may be randomly generated. Subsequently, the author encrypts the DEK using a public key a provider provides (block 306), where the provider is part of the content distribution portal. The provider's public key may be retrieved from a public key server or a certificate authority, cf. FIG. 1B. For the asymmetric encryption the RSA algorithm may be used. Then the encrypted digital content, the associated rights specified by the author and the encrypted DEK are sent to the provider (block 308). In response, the provider stores the encrypted DEK, the associated rights and the encrypted digital content (block 310) and starts offering the newly added digital content (block 312).

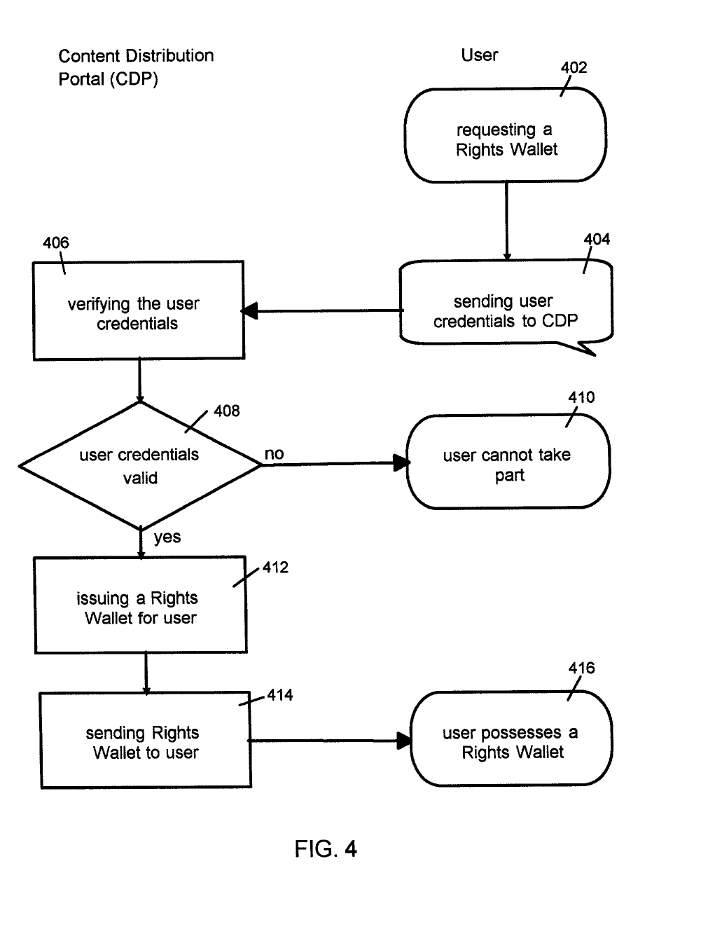

FIG. 4 shows a flowchart illustrating a method of acquiring a rights wallet in accordance with the present invention. A user requests a rights wallet (block 402) by sending a request, containing credentials referring to the user, to the content distribution portal (block 404). The credentials may be composed by a certificate issued by a certificate authority, a unique ID or a pseudonym of the user. In response, the content distribution portal verifies the user's credentials (block 406) by accessing the certificate authority or any other office that might have issued the respective credentials and checking whether or not the credentials are valid (block 408); at the same time the CDP may optionally check other criteria for allowing new rights wallets to be issued. If the user credentials are not valid, the user cannot get a rights wallet (block 410). If the user credentials are valid, a new rights wallet is issued for the user, i.e., a new unique ID is created for the rights wallet and the ID is stored together with a reference to the user (block 412). Then the rights wallet is sent to the user (block 414) which then possesses a rights wallet (block 416). However, it is acknowledged that rights wallets may be issued by an entity that is independent from the content distribution portal, a so called rights wallet authority. The independence of the rights wallet authority from the content distribution portal would advantageously allow the user to collect music from multiple CDPs.

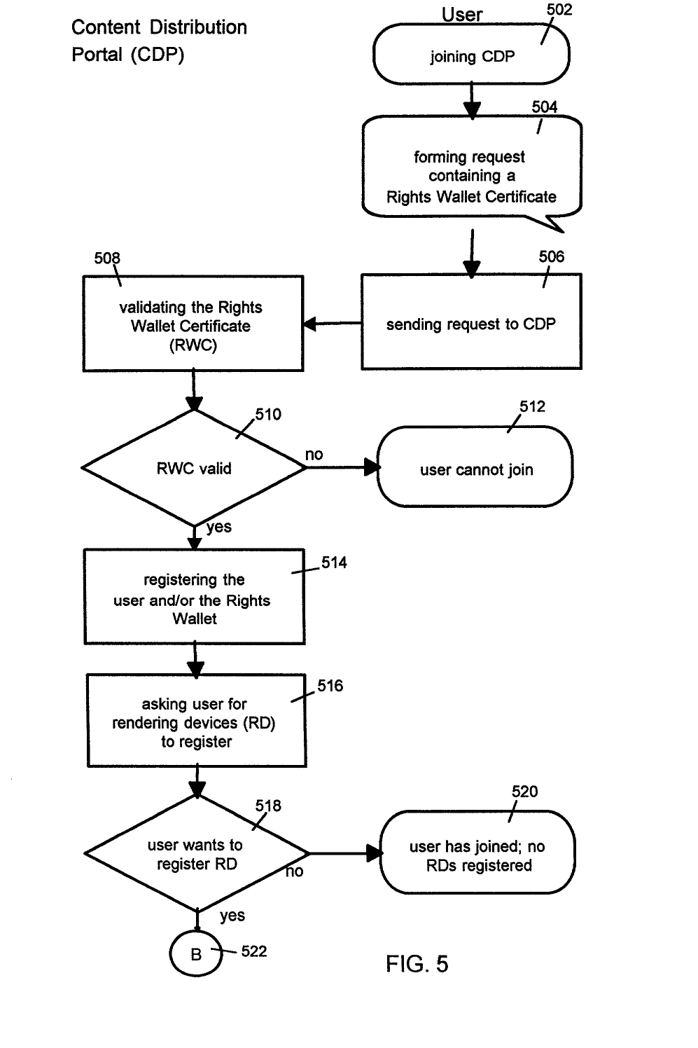

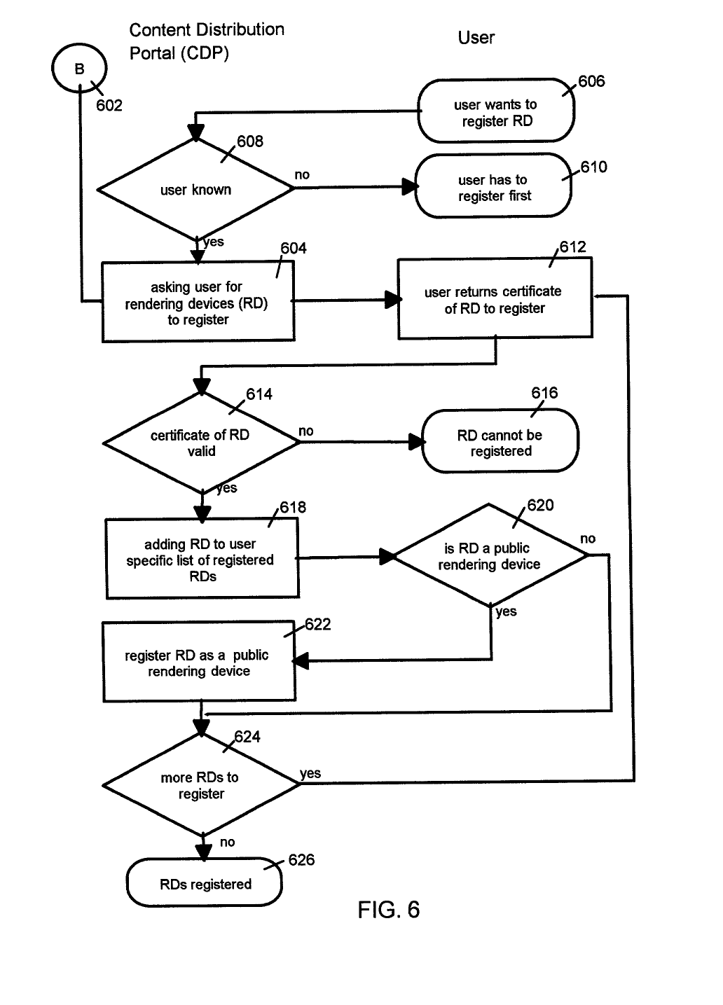

FIG. 5 shows a flowchart illustrating a method of registering a user with a content distribution portal (CDP) in accordance with the present invention. Whenever a user wants to join the community of users registered with the content distribution portal (block 502) a request is formed (block 504). The request may contain a certificate proving that the user already possesses a rights wallet. This might be the case if the content distribution portal offers different membership schemes. Alternatively it is possible that the user gets a rights wallet when registering with a content distribution portal. The actual registration process is launched by sending the request to the CDP (block 506). The certificate may be issued by the certificate authority (cf. FIG. 1B). When the CDP receives the request it validates the rights wallet certificate (block 508), which proves that the user sending the request is the actual holder of the rights wallet, by checking whether or not the rights wallet certificate is valid (block 510). If the rights wallet certificate is not valid, the user cannot join, and the request gets rejected (block 512). If the rights wallet certificate is valid, the user and/or the rights wallet are registered (block 514). Since each rights wallet contains a reference to the user it is possible for the CDP to just keep a list of all rights wallets registered instead of additionally keeping a list of all users. Now, a message is sent to the user asking whether or not a rendering device is to be registered (block 516). Then the user's response is analyzed (block 518). If the user wants to register a rendering device, the process is continued with the process of registering rendering devices with the CDP (block 522; cf. FIG. 6). If the user does not want to register a rendering device, there is no need to continue the process; however, the user has joined as a registered customer (block 520).

FIG. 6 shows a flowchart illustrating a method of registering one or more rendering devices with a content distribution portal in accordance with the present invention. This process has two entry points. The first is the continuation of the process shown in FIG. 5. If the user wants to register rendering devices (block 602), the user is asked for the rendering devices to be registered (block 604).

Alternatively, the user can request the registration of a new rendering device at any time (block 606). Then the content distribution portal (CDP) checks whether or not the user is already known to it (block 608). If not, the user is asked to register first (block 610). If the user is already known to the CDP, the user is asked for the rendering devices to be registered as for the first entry point (block 604).

In response the user returns a certificate for the rendering device to be registered (block 612). Subsequently, the CDP checks whether or not the certificate of the rendering device is valid (block 614). If it is not, the rendering device cannot be registered (block 616). If the rendering device is valid, a reference to the rendering device is added to the user-specific list of registered rendering devices (block 618). A distinction is made if the rendering device is used as a public rendering device (block 620). If this is the case, the rendering device is registered as a public rendering device (block 622) and the user is subsequently asked whether or not he wants to register more rendering devices (block 624). If this is not the case, then the user is immediately asked whether or not he wants to register more rendering devices (block 624). If so, then the process continues at block 612 as described above. If not, the process ends having the rendering device(s) registered (block 626).

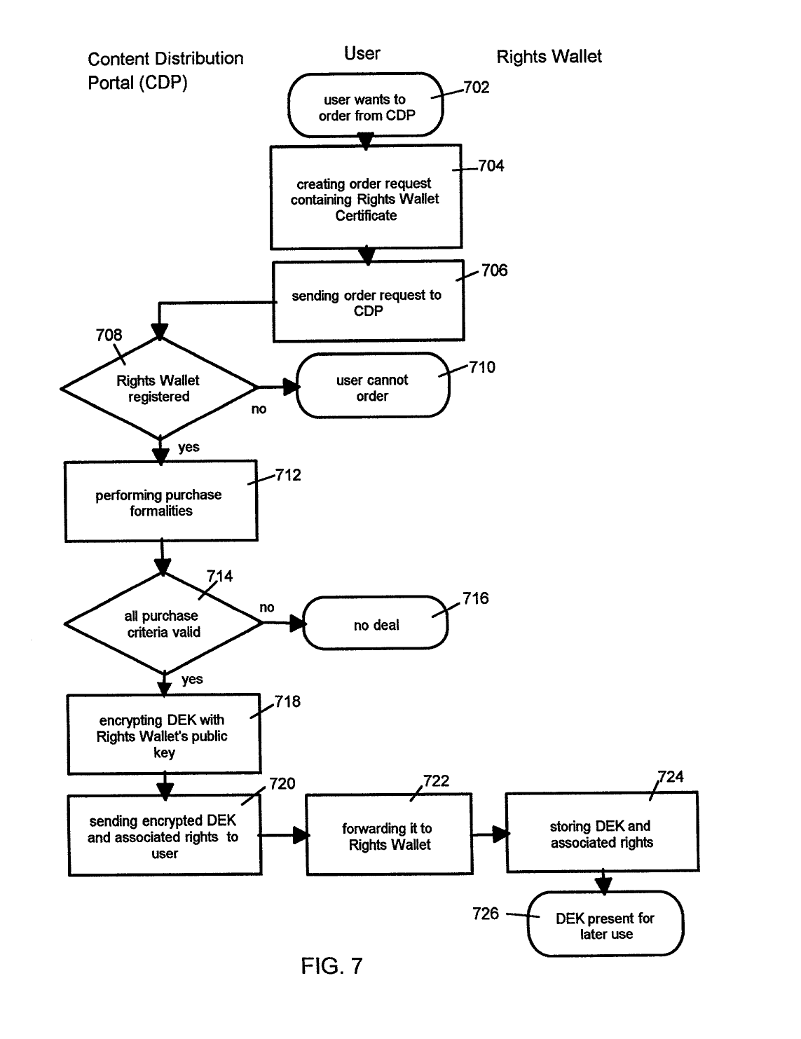

FIG. 7 shows a flowchart illustrating a method of ordering from a content distribution portal in accordance with the present invention. If a user wishes to order some content, e.g., a music recording, from the content distribution portal (block 702), he may use the environment provided by the CDP for searching, selecting. Whenever the user has made up his mind, he creates an order request to be sent to the CDP (block 704). This may be done by using an interactive web site as commonly known and widely used in the art. The order request contains a rights wallet certificate identifying the rights wallet and ensuring that it is a valid one. Subsequently, the order request is being transmitted to the CDP via a communication link, such as the Internet (block 706). In return, the CDP checks whether or not the rights wallet is valid and registered to the requesting user (block 708). If not, the user is not allowed to order and a respective explanatory message is returned to the user (block 710). If yes, purchase formalities are performed, such as requesting and receiving a credit card number (block 712). Then, the CDP examines whether or not all purchase criteria are met and valid (block 714). If not, again the user is not permitted to make a deal with the CDP, i.e., the CDP refuses to sell the requested digital content to the user (block 716). A respective explanatory message may be returned to the user.

If all purchase criteria are valid, the document encryption key (DEK) is encrypted by using a public key associated with the rights wallet (block 718). The public key associated with the rights wallet may be transmitted to the CDP together with the rights wallet certificate. Alternatively, the CDP may request the respective public key from a certificate authority or a public key authority. Afterwards, the encrypted DEK and access rights associated with the purchased digital content are transmitted to the user (block 720). The user forwards it to the rights wallet (block 722) that, in response, stores the DEK and the rights associated with the digital content (block 724). Alternatively, a primary communication link may be established directly between the CDP and the respective rights wallet. The rights wallet however is able to decrypt the DEK with its own private key. Finally, the DEK is present in the rights wallet for later use (block 726), i.e., whenever the purchased digital content needs to be rendered.

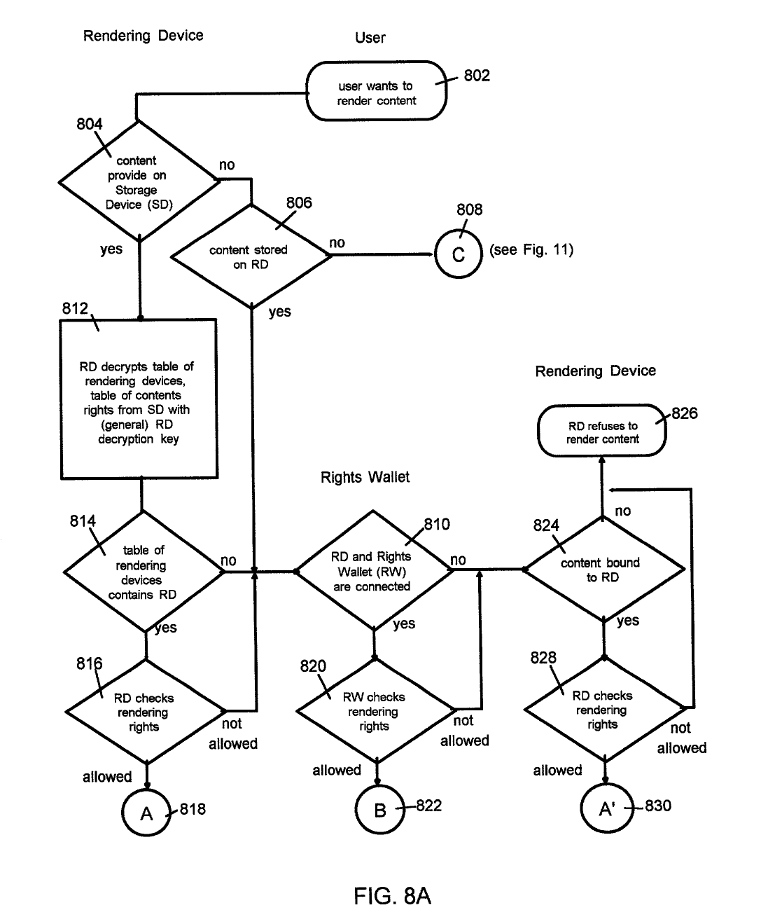

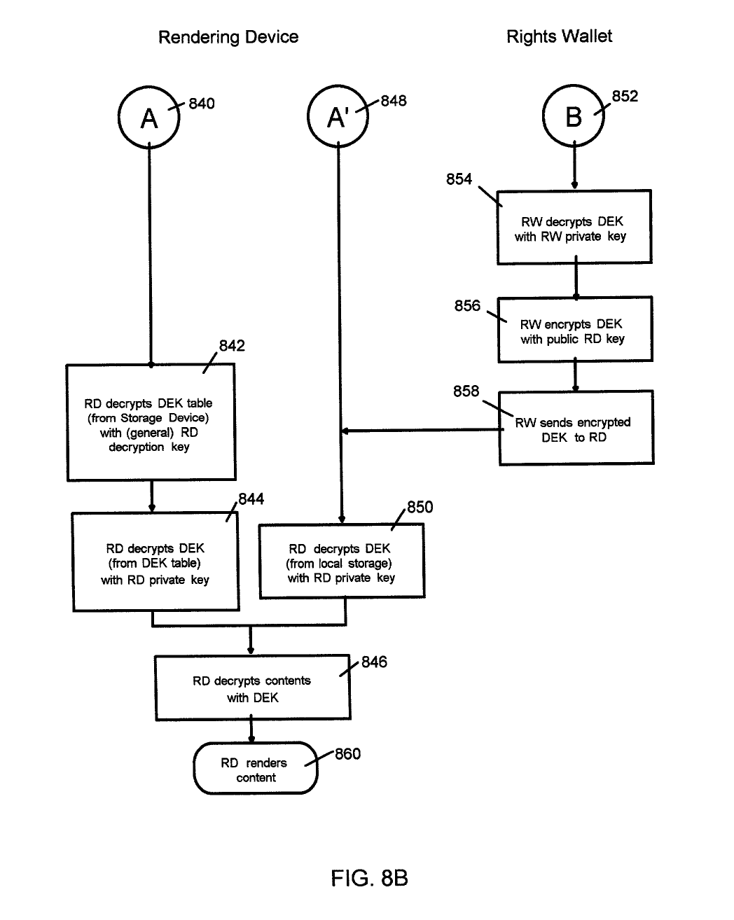

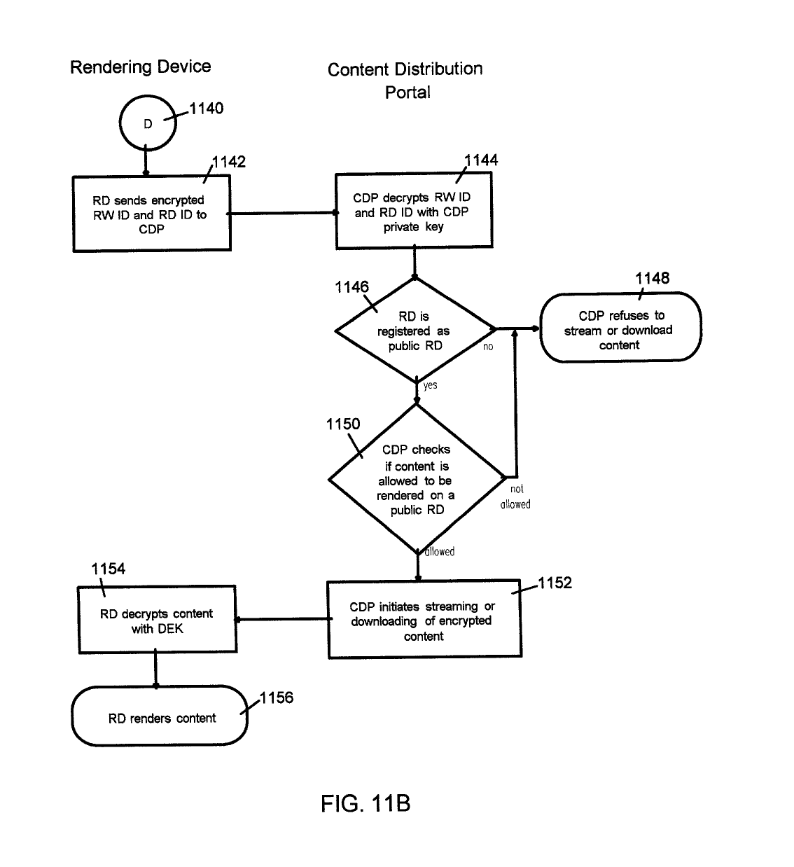

FIG. 8A shows a flowchart illustrating a method of rendering digital content in accordance with the present invention. When a user wants to render some digital content (block 802), he activates a rendering device. The rendering device checks whether or not the digital content is provided on a storage device which may be externally attached to the rendering device, e.g., a CD or a DVD (block 804). If the content is not provided on an attached storage device, the rendering device checks whether or not the digital content is stored internally, e.g., on an integrated hard disk or some nonvolatile solid-state memory device such as a flash memory (block 806). If not, the process is continued as shown in FIG. 11 (block 808). If the content has been found as being stored on the rendering device itself, the rendering device checks whether or not it is connected to the user's rights wallet (block 810).

If at block 804 the rendering device has detected the digital content requested to be rendered on the external storage device, the rendering device decrypts a table of rendering devices and a table of contents rights from the storage device with a general rendering device decryption key (block 812). Alternatively, the rendering device may check a digital signature applied on the aforementioned tables to prove their validity. Subsequently, the rendering device examines whether or not the table of rendering devices stored on the storage device contains an identifier referring to the rendering device itself (block 814). If not, the rendering device continues by checking whether or not the rendering device is connected to the user's rights wallet at block 810.

If the table of rendering devices stored on the storage device does contain an identifier referring to the rendering device itself, the rendering device checks the access rights granted (block 816). If the requested form of rendering, such as copying, printing, converting in visible, auditible or tangible form, is allowed by the granted access rights, the method is continued in FIG. 8B (block 818). If not, again the rendering device continues by checking whether or not the rendering device is connected to the user's rights wallet at block 810.

If at block 810 the rendering device is connected to the user's rights wallet, the rights wallet checks whether or not the user possesses the needed access rights to render the digital content in the requested way (block 820). If rendering is allowed the method is continued in FIG. 8B (block 822). If the requested rendering is not allowed, the rendering device tests whether or not the digital content is bound to the rendering device itself (block 824). If not, the method terminates by the rendering device refusing to render the content (block 826). If the digital content is bound to the rendering device, the rendering device checks the respective access rights (block 828). If the digital content is bound to the rendering device, but the requested rendering mode is not allowed by the access rights granted, the method ends by the rendering device refusing to render the content at block 826. If the rendering rights allow the requested rendering mode, the method is continued in FIG. 8B (block 830).

FIG. 8B is a continuation of the flowchart of FIG. 8A. After the first entry point (block 840) the method is continued by the step of the rendering device decrypting the document encryption key (DEK) table, which contains the DEK(s) encrypted for it, from the storage device with a general rendering device decryption key (block 842). Then the rendering device decrypts the document encryption key (DEK) from the DEK table with its private key (block 844). Subsequently, the rendering device decrypts the digital content with the DEK (block 846).

From the second entry point (block 848) the method reaches the step in which the rendering device decrypts the DEK from the local storage with the rendering device private key (block 850). Again the method is continued by the rendering device subsequently decrypting the digital content with the DEK at block 846.

From the third entry point (block 852), the rights wallet decrypts the DEK with the rights wallet private key (block 854). Then the rights wallet encrypts the DEK with the public key associated with the rendering device (block 856). Afterwards, the rights wallet sends the newly encrypted key to the rendering device (block 858) which in return decrypts the DEK with its private key at block 850 and the digital content with the obtained decrypted DEK at block 846. Finally, the rendering device renders the content as requested by the user (block 860).

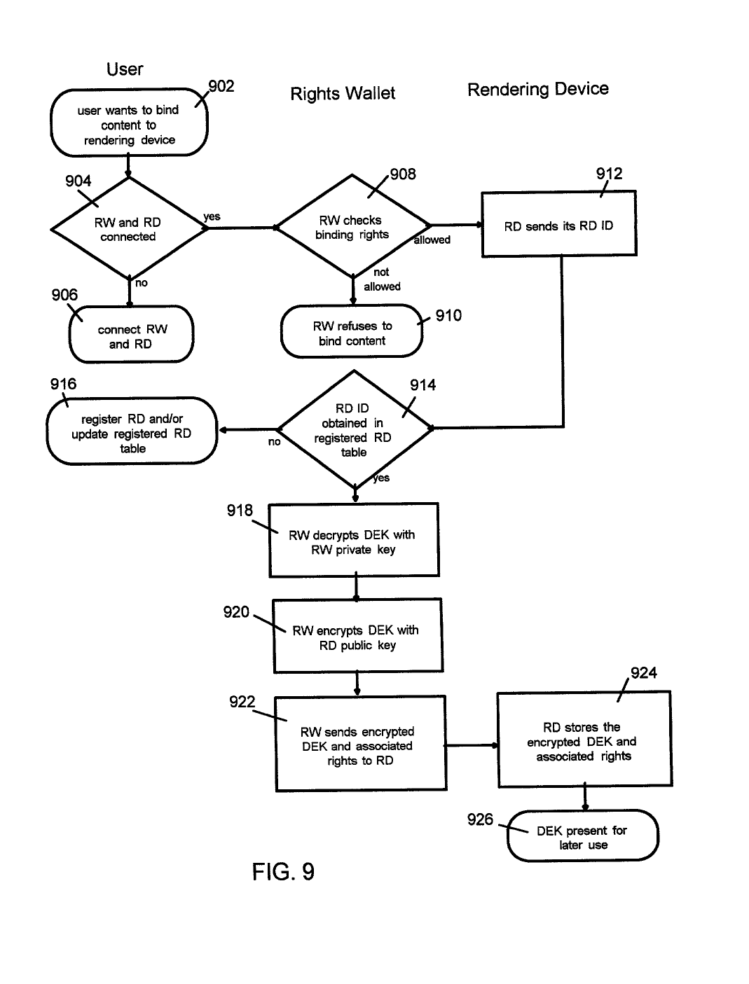

FIG. 9 shows a flowchart illustrating a method of binding digital content to a rendering device in accordance with the present invention. If a user wants to bind digital content to a rendering device (block 902), he has to ensure that the rendering device and his rights wallet are able to establish a communication connection between each other. A check is therefore made of whether or not the rights wallet and the rendering device are connected (block 904). If they are not, the user is requested by a explanatory message issued by the rendering device or the rights wallet to make a connection possible (block 906) and the method ends. If the rights wallet and the rendering device are connected, the rights wallet checks whether or not it is allowed by the granted access rights to bind the respective digital content to a particular rendering device (block 908). If this is not allowed the method terminates by informing the user that the rights wallet refuses to bind the digital content (block 910). If binding the content is allowed, the rendering device sends its identification to the rights wallet, preferably in form of a digital certificate (block 912). Subsequently, the rights wallet examines whether or not the obtained identification is registered in the rendering device table (block 914). If not, the rendering device needs to get registered and/or the registered rendering device table needs to get updated first, and the method ends (block 916). If the obtained identification is registered in the rendering device, the rights wallet decrypts the document encryption key (DEK) with the rights wallet private key (block 918). Then it encrypts the DEK with the public key associated with the rendering device (block 920). Subsequently, the rights wallet sends the newly encrypted DEK and the associated access rights to the rendering device (block 922). In response the rendering device stores the encrypted DEK and the associated rights (block 924). Finally, the DEK is present in the rendering device for a later use (block 926).

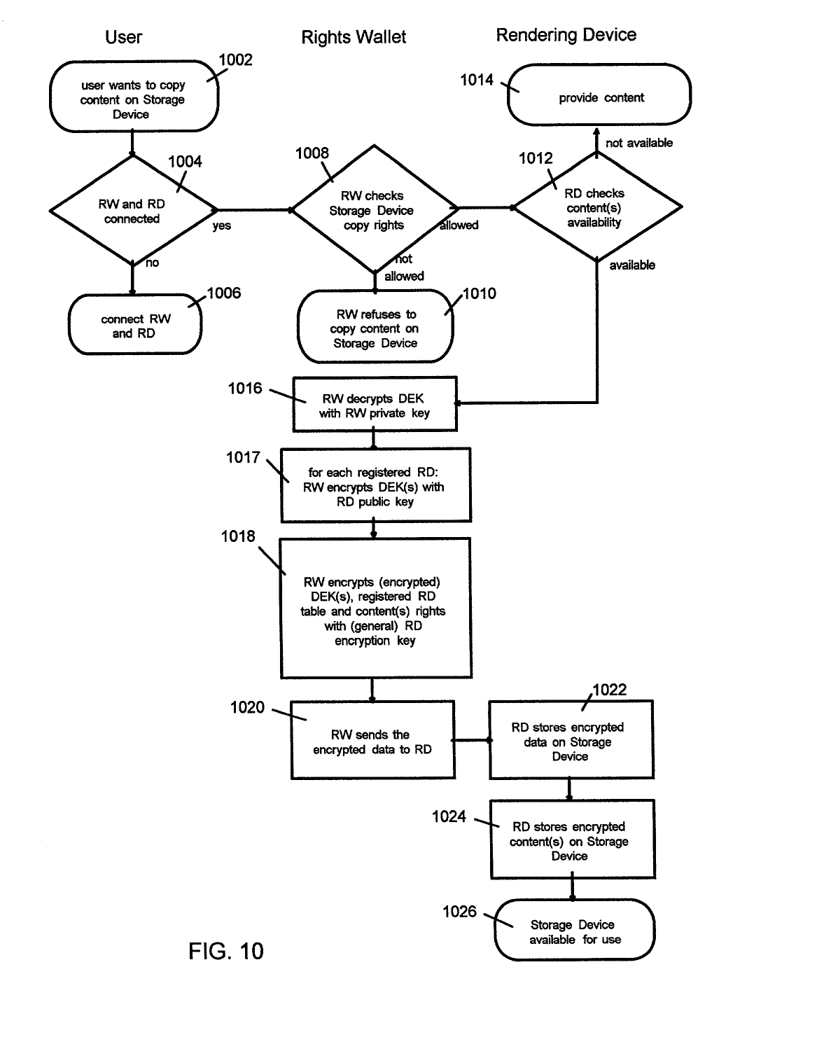

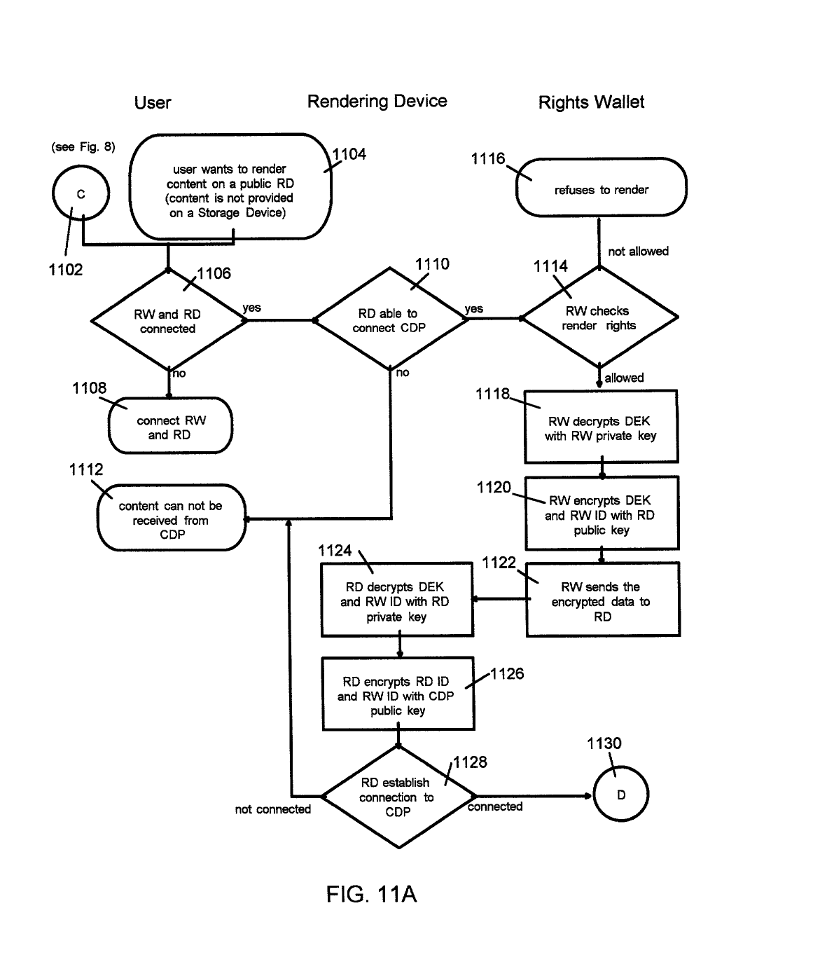

FIG. 10 shows a flowchart illustrating a method of copying digital content to a storage device in accordance with the present invention. If a user wants to copy digital content to a storage device, he has to ensure that the rendering device and his rights wallet are able to establish a communication connection between each other (block 1002). A check is therefore made of whether or not the rights wallet and the rendering device are connected (block 1004). If not, the user is requested by a explanatory message issued by the rendering device or the rights wallet to make a connection possible (block 1006) and the method ends. If the two are connected, the rights wallet checks whether or not it is allowed by the granted access rights to copy the respective digital content to the particular storage device (block 1008). If this is not allowed, the method terminates by informing the user that the rights wallet refuses to copy the digital content (block 1010). If copying the content is allowed the rendering device checks the availability of the content (block 1012). If the content is not available the user is requested by a explanatory message issued by the rendering device to make a the digital content available (block 1014) and the method terminates. If the digital content is available, the rights wallet decrypts the respective document encryption key (DEK) with the private key associated with the rights wallet (block 1016). Then, the rights wallet encrypts for each registered rendering device the DEK with the rendering device public key (block 1017). The rights wallet encrypts the list of DEKs, the list of rendering devices stored in the respective rights wallet table and the associated access rights with a general rendering device encryption key (block 1018). Subsequently, it sends the encrypted data to the rendering device (block 1020). In response, the rendering device stores the encrypted data on the storage device (block 1022) and also the encrypted content (block 1024). Finally, the storage device is available for later use (block 1026).

FIG. 11A shows a flowchart illustrating a method of rendering digital content on a public rendering device in accordance with the present invention. The shown method has two major entry points. The first entry point is a continuation of the method shown in FIG. 8 (block 1102), while the second entry point is used whenever the user wants to render digital content on a public rendering device, where the digital content may not be provided on a storage device (block 1104). In an initial step it is determined whether or not the user's rights wallet and the rendering device are connected so that they can intercommunicate (block 1106). If not, the user is requested by a explanatory message issued by the rendering device or the rights wallet to make a connection possible (block 1108) and the method ends. If the rights wallet and the rendering device are connected, the rendering device checks whether or not it is able to connect to the content distribution portal (block 1110). If it is not, i.e., the rendering device is unable to connect, the method terminates with issuing an explanatory message to the user that the digital content could not be received from the CDP (block 1112). If the rendering device is able to establish a connection to the CDP, the rights wallet checks whether or not the user is allowed to render the digital content (block 1114). If the user is not allowed, the rights wallet presents a message informing the user that it refuses to render the digital content (block 1116). The user needs to purchase the respective access rights first.

However, if the user has already purchased the necessary access rights, i.e., the user is allowed to render the digital content, the rights wallet decrypts the DEK using the private key associated with the rights wallet (block 1118). Then, the it encrypts the DEK and the rights wallet's identification with the public key associated with the respective rendering device (block 1120). Subsequently, the rights wallet sends the encrypted data to the rendering device (block 1122). In response, the rendering device decrypts the DEK and the rights wallet's identification with the private key associated with the rendering device (block 1124). Then the rendering device encrypts the rendering device's identification and the rights wallet's identification with the public key associated with the CDP (block 1126). Subsequently, it examines whether or not it is able to establish a connection to the CDP (block 1128). If not, i.e., the rendering device is unable to connect, the method terminates with issuing an explanatory message (cf. block 1112). If the rendering device is able to establish a connection to the CDP, the method is continued in FIG. 11B (block 1130).

FIG. 11B is a continuation of the flowchart of FIG. 11A. Starting with the continuation of FIG. 11A (block 1140), the rendering device sends the encrypted rendering device's identification and the encrypted rights wallet's identification to the CDP (block 1142). In response, the CDP decrypts the encrypted information with its private key (block 1144) and checks whether or not the rendering device is registered as a public rendering device (block 1146). If not, the CDP refuses to stream or download the requested content and the method ends (block 1148). A message may be send back to the rendering device that informs the user accordingly.

If the rendering device is registered as a public rendering device, the CDP checks whether or not the requested digital content is allowed to be rendered on a public rendering device (block 1150). If not, the CDP refuses to stream or download the requested content and the method ends at block 1148. If it is allowed, the CDP initiates streaming or downloading of the requested digital content in encrypted form (block 1152). In response, the rendering device decrypts the content with the DEK (block 1154). Finally, the rendering device renders the requested content (block 1156).

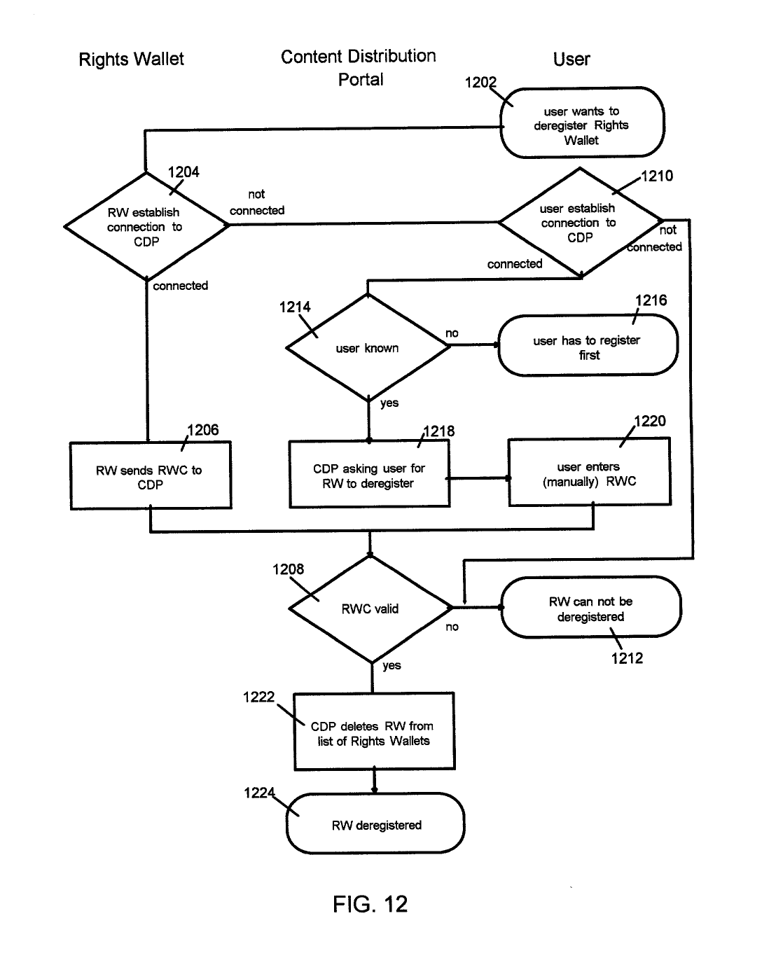

FIG. 12 shows a flowchart illustrating a method of deregistering a rights wallet in accordance with the present invention. If a user wants to deregister a rights wallet (block 1202), he has to ensure that his rights wallet and the content distribution portal are able to establish a communication connection between each other. Therefore, a check is made of whether or not the rights wallet and the CDP have established a connection (block 1204). If so, the rights wallet sends a corresponding rights wallet certificate to the CDP (block 1206). In response, the CDP checks whether or not the rights wallet certificate is valid (block 1208). If no connection could be established between the rights wallet and the CDP, the user is requested by an explanatory message issued by the rights wallet to make a connection possible and then it is checked whether or not the user has been successful (block 1210). If the user failed to establish a connection, the rights wallet cannot be deregistered and the method ends (block 1212). However, if the user succeeds, the CDP checks whether or not the user is known to it (block 1214). If not, the user has to register first (block 1216). A explanatory message may be issued to the user. If the user is known to the CDP, the CDP asks the user for the identification of the rights wallet to be deregistered (block 1218). In response, the user enters manually the rights wallet certificate (block 1220). Subsequently, the CDP checks whether or not the rights wallet certificate is valid at block 1208. If not, the rights wallet cannot be deregistered and the method ends at block 1212. If the rights wallet certificate is valid, the CDP deletes the rights wallet from the list of rights wallets registered for the respective user (block 1222). Finally, the rights wallet is deregistered (block 1224).

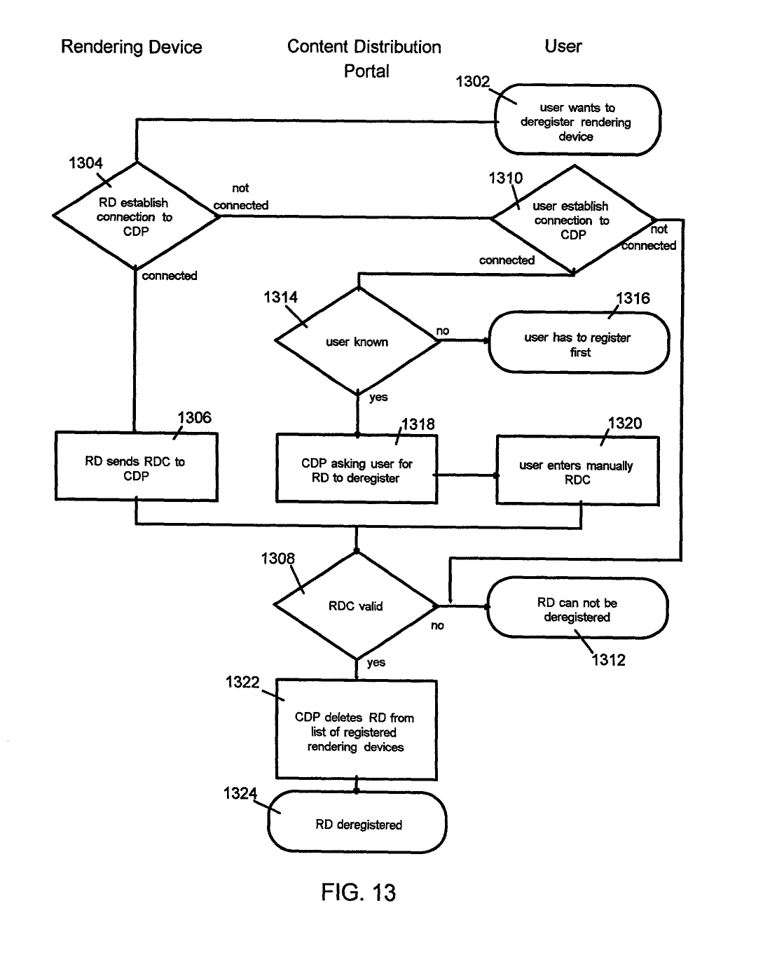

FIG. 13 shows a flowchart illustrating a method of deregistering a rendering device in accordance with the present invention. Whenever a user wishes to deregister a rendering device (block 1302), he has to ensure that the particular rendering device and the content distribution portal are able to establish a communication connection between each other. Therefore, a checked is made of whether or not the rendering device and the CDP have established a connection (block 1304). If they have, the rendering device sends a corresponding rendering device certificate to the CDP (block 1306). In response, the CDP checks whether or not the rendering device certificate is valid (block 1308). If no connection could be established between the rendering device and the CDP, the user is requested by an explanatory message issued by the rendering device to make a connection possible and then it is checked whether or not the user has been successful (block 1310). If the user failed to establish a connection, the rendering device cannot be deregistered and the method ends (block 1312). However, if the user succeeds, the CDP checks whether or not the user is known to it (block 1314). If not, the user has to register first (block 1316). A explanatory message may be issued to the user. If the user is known to the CDP, the CDP asks the user for the identification of the rendering device to be deregistered (block 1318). In response, the user enters manually the rendering device certificate (block 1320). Subsequently, the CDP checks whether or not the rendering device certificate is valid (cf. block 1308). If not, the rendering device cannot be deregistered and the method ends (cf. block 1312). If the certificate is valid, the CDP deletes the rendering device from the list of rendering devices registered for the respective user (block 1322). Finally, the rendering device is deregistered (block 1324).

The present invention can be realized in hardware, software, or a combination of hardware and software. Any kind of computer system or other apparatus adapted for carrying out the methods described herein is suited. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which when loaded in a computer system is able to carry out these methods.

Computer program means or computer program in the present context means any expression, in any language, code or notation, of a set of instructions intended to cause a system having an information processing capability to perform a particular function either directly or after either or both of the following a) conversion to another language, code or notation; b) reproduction in a different material form.

What is claimed is:

1. A framework for controlling access rights to digital content in a distributed information system comprising:
first storage means for storing a reference to a user registered in said framework;
second storage means for storing a reference to digital content registered for said user; and
third storage means for storing a reference to a digital secure repository registered for said user, the digital secure repository containing storage means for storing a unique identifier and a reference to said digital content.

2. The framework according to claim 1, further comprising:
fourth storage means for storing a reference to a rendering device registered for said user.

3. The framework according to claim 1, further comprising:
a communication link for establishing communication to one or more of the set of said secure repository and said rendering device.

4. The framework according to claim 1, wherein said secure repository further comprises storage means for storing a digital key for decrypting said digital content.

5. The framework according to claim 1, wherein said secure repository further comprises storage means for storing a reference to a rendering device.

6. The framework according to claim 1, wherein said secure repository further comprises storage means for storing content rights for said digital content.

7. The framework according to claim 1, wherein said secure repository further comprises storage means for storing a reference to said user.

8. The framework according to claim 1, wherein said secure repository further comprises a communication link for establishing communication to one or more of the set of said framework and said rendering device.

9. The framework according to claim 1, wherein the framework is realized as a set of web applications forming an Internet web site.

10. An Internet web site offering a framework for controlling access rights to digital content in a distributed information system according to claim 1.

11. A method for controlling access rights to digital content in a distributed information system comprising the steps of:
registering a user with a framework for controlling access rights to digital content in said distributed information system;
registering a digital secure repository registered for said user; and
registering digital content registered for said user.

12. The method according to claim 11, wherein registering a user further comprises the steps of:
receiving a message from said user comprising a reference to said digital secure repository;
validating said reference to said digital secure repository; and
storing a reference to said user.

13. The method according to claim 11, wherein registering a digital secure repository further comprises the steps of:
receiving a message from said user comprising credentials of the user;
validating said credentials;
if the credentials are valid, issuing a new digital secure repository; and
storing a reference to said issued digital secure repository and sending it to the user.

14. The method according to claim 11, wherein registering digital content further comprises the steps of:
receiving a message from said user comprising an order request and a reference to the user's digital secure repository;
validating said reference;
if the reference is valid, performing purchase formalities;
if all formalities are performed, encrypting the document encryption key associated with the requested digital content with the public key associated with said digital secure repository; and
returning the encrypted document encryption key to the user and registering the purchased digital content for said user.

15. The method according to claim 11, further comprising the step of registering a rendering device for said user.

16. The method according to claim 15, wherein registering a rendering device further comprises the steps of:
receiving a message from said user comprising credentials of the user and a reference to said rendering device to be registered;
validating said credentials;
if the credentials are valid, storing the reference of the rendering device associated with said user.

17. A computer program product stored on a computer usable medium, comprising computer readable program means for causing a computer to perform a method according to claim 11.

18. A method for rendering digital content on a rendering device comprising the steps of:
receive a request for rendering digital content in a predetermined form;
reading information about access rights granted;
if access rights cover the requested form of rendering the digital content, getting a document encryption key encrypted with the public key associated with said rendering device;
decrypting the document encryption key with the private key associated with said rendering device;
decrypting said digital content with said document encryption key; and
rendering said digital content in the requested form.

19. The method for rendering digital content on a rendering device according to claim 18, wherein the step of getting a document encryption key further comprises the steps:
determining from a storage device associated with said rendering device whether or not the digital content is bound to said rendering device and if yes receiving said document encryption key from said storage device.

20. The method for rendering digital content on a rendering device according to claim 18, wherein the step of getting a document encryption key further comprises the step of receiving said document encryption key from a digital secure repository.

21. The method for rendering digital content on a rendering device according to claim 18, wherein the step of reading from a digital secure repository further comprises the step of communicating with said digital secure repository over a communication link.

22. The method for rendering digital content on a rendering device according to claim 18, wherein the step of reading from a digital secure repository further comprises the step of retrieving said digital secure repository from a storage device also keeping said digital content.

23. The method for rendering digital content on a rendering device according to claim 18, wherein the step of decrypting said digital content further comprises the step of retrieving said digital content from a storage device.

24. The method for rendering digital content on a rendering device according to claim 18, wherein the step of decrypting said digital content further comprises the step of retrieving said digital content from over a communication link as downloaded or streaming data.

25. A computer program product stored on a computer usable medium, comprising computer readable program means for causing a computer to perform a method according to claim 18.

26. A method for binding digital content to a rendering device, the method comprising the following steps:
establishing a connection from said rendering device to a digital secure repository;
requesting from said digital secure repository digital content rights for specified digital content;
if binding is allowed according to the rights stored in said digital secure repository, receiving the respective document encryption key encrypted with the rendering device's public key, and storing the encrypted key for later decrypting the respective digital content.

27. A computer program product stored on a computer usable medium, comprising computer readable program means for causing a computer to perform a method according to claim 26.

28. A method for storing digital content from a rendering device onto a storage device, the method comprising the following steps:
establishing a connection from said rendering device to a digital secure repository;
requesting from said digital secure repository digital content rights for specified digital content;
if storing is allowed according to the rights stored in said digital secure repository, receiving the respective document encryption key encrypted with the respective public key of all rendering devices registered in said digital secure repository, and storing the encrypted keys together with said encrypted digital content on said storage device.

29. A computer program product stored on a computer usable medium, comprising computer readable program means for causing a computer to perform a method according to claim 28.
